(19) United States
(12) Patent Application Publication
(10) Pub. No.: US 2017/0083854 A1
(43) Pub. Date: Mar. 23, 2017

(54) Asset Tracking and Share Management System

(71) Applicants: Charles E. Elyea, Charlotte, NC (US); Christopher J. Wirtz, III, Fort Mill, SC (US); Ian Grieve, Shotley Bridge (GB); Gary Boon, Newcastle upon Tyne (GB); Andrew Allen Watts, III, Charlotte, NC (US)

(72) Inventors: Charles E. Elyea, Charlotte, NC (US); Christopher J. Wirtz, III, Fort Mill, SC (US); Ian Grieve, Shotley Bridge (GB); Gary Boon, Newcastle upon Tyne (GB); Andrew Allen Watts, III, Charlotte, NC (US)

(73) Assignee: ShareMyToolbox, LLC, Charlotte, NC (US)

(21) Appl. No.: 15/269,638

(22) Filed: Sep. 19, 2016

Related U.S. Application Data
(60) Provisional application No. 62/220,154, filed on Sep. 17, 2015.

(51) Int. Cl. G06Q 10/08; G06Q 50/00; G06F 17/30

(52) U.S. Cl. CPC G06Q 10/087; G06F 17/30879; G06Q 50/01

(57) ABSTRACT

A system for sharing and tracking tools among users in the field without need of a centralized tool repository, the users include tool owners and tool owners' connections, each user having a mobile device in communication with a remote server to track tools and facilitate transactions between users, a call to action on a mobile device of a requesting user includes a request to borrow, loan, or transfer a specific tool from one user to another, a suitable notification is sent to relevant users based on the call to action, and upon physical transfer of the specific tool to the intended recipient, a tool record associated with the specific tool is updated to identify the current user in physical possession of the specific tool. Tools are selected for a transaction on the mobile device or using a bar code or RFID on or associated with the specific tool.

### CROSS REFERENCE TO RELATED APPLICATIONS

The patent application claims priority benefit under 35 U.S.C. §119(e) of U.S. Prov. Pat. Appl. No. 62/220,154, entitled “Peer-to-Peer Tool Sharing, Tracking, and Management System,” filed Sep. 17, 2015, which is incorporated herein by reference in its entirety.

### FIELD OF THE PRESENT TECHNOLOGY

The present invention relates to mobile device software applications and, more particularly, to methods and systems for tracking and sharing tools or other small assets in a distributed, field, or multipoint network of interconnected users.

### BACKGROUND OF THE PRESENT TECHNOLOGY

Small tools, such as drills and saws, are treated as consumables and expensed by most companies. For example, in a recent survey by the Institute of Construction Industry Financial Professionals, 86% of the contractors surveyed expense tool purchases below $1,000. Typically, if an asset is not capitalized, it is not tracked.

Contractors replace 20-40% of their total tool value on an annual basis. Individually, tools are de minimis in value, but, in the aggregate, a contractor typically has a significant financial investment in tool inventory. Tools are frequently left on jobsites, lost, stolen, or borrowed for personal use but without any way of knowing or tracking who borrowed the tool.

Because tool availability is uncertain, many employees of a contractor end up hoarding tools for future use, which prevents other employees from having access to or knowing where the needed tool is currently located. Often, new tools are purchased or rented even though the contractor has tools available—simply because the idle tool is in the possession of another employee and/or its location is unknown and it takes less time and effort to buy or rent the needed tool than to try to find or track down a tool in another employee's possession. Employees are often unaware of what tools the company even owns or who has them. Typically, there is no accountability for tool usage.

Existing legacy applications for tool management are both expensive and designed primarily for tracking the movement of assets to and from a storage location. Tools are barcoded and scanned out to the responsible party and tool tracking requires a dedicated asset manager to man the storage location. Transferring tools in the field also requires the tool administrator to update the tool database. Reports can be generated by category of asset, status, and location; however, there is little accountability with field employees since they cannot easily access tool information.

Typically, tool sharing, tracking, and management would be of benefit to enterprises that have multiple employees who need or have access to a pool of shared tools used by such employees as part of their day-to-day job. Such enterprises will typically include contractors, property managers, manufacturers, automotive shops, and similar types of businesses.

Tool sharing, tracking, and management would also be of tremendous benefit to individuals and the do-it-yourself (DIY) home repair and renovation crowd. Typically, individual consumers have a toolbox of hand tools and equipment that includes everyday tools (e.g., hammer, screw drivers, wrenches, etc.) and any specialized tools that the consumer has needed and bought at some point in the past for a specific project. Often, such specialized tools may only be needed for one project and may never be needed again. Generally, there is not a market for renting small tools from a hardware store since the cost to buy the tool is low enough compared to the rental cost and hassle of renting and returning the tool.

Neighbors often borrow and share tools with each other, but there is no good way for one neighbor to know what tools another neighbor may have. In addition, it is fairly common for such borrowed tools to end up never being returned—with the owner not knowing or remembering which neighbor borrowed the tool.

For all of the above reasons, a need exists at the consumer level and also at the enterprise level, for methods and systems that make it easy for a tool owner to create and identify the owner's inventory of tools and equipment that are available for use by employees of an enterprise tool owner or by the social network of an individual tool owner. Further advantages of the methods and systems described herein will become apparent to one of skill in the art after reviewing the remainder of the present application with reference to the drawings and detailed description which follows.

The above needs and features, as well as additional aspects and business applications, are disclosed herein and will become readily apparent to one of ordinary skill in the art after reading and studying the following summary of the present inventions, the detailed description of preferred embodiments, and the claims included hereinafter. The present inventions meet one or more of the above-referenced needs as described herein in greater detail.

### SUMMARY OF THE PRESENT TECHNOLOGY

The present invention relates to mobile device software applications and, more particularly, to methods and systems for tracking and sharing tools or other small assets in a distributed, field, or multipoint network of interconnected users.

The present invention disclosed and described herein is a mobile-first application for small tool management—built on a peer-to-peer sharing platform. “Mobile-first” means the application was designed from the ground up and intended for use by users primarily on mobile or handheld devices. Although end users will typically interface with the application on a mobile or handheld device, with as many functions as possible being performed only on the mobile device and with the user experience (UX) being optimized for mobile, an administrative web interface is available for enterprise-based users. In addition, even though users will primarily interface with the application on a mobile or handheld device, it is contemplated that the application itself will interface with cloud-based servers for management of databases of tool inventory and user relationships/connections.

Preferably, a tool owner creates a catalog or library of tools and makes “connections” similar to existing social media applications, such as Facebook and LinkedIn. The difference is that the present application is built upon a private social network. For consumer tool owners, connections may be friends, family, neighbors, or co-workers. For enterprise tool owners, connections will be all employees who use or need access to the enterprise's inventory of tools.

Connected users create a master catalog of sharable assets (tools) that can be searched for availability. If a tool is located and available, it can be requested and the length of time needed can be specified. Tool tracking and accountability is thus transferred solely from the tool owner to a social network of users.

Preferably, the application includes the following functionality and features: (i) a cloud-based database for storing information about users and their tool inventory that is accessible by the application; (ii) a library/catalog/inventory of tools created by each tool owner; (iii) procedures and protocols for enabling users to “connect” with other tool owners or other employees within an enterprise; (iv) the ability to mark or designate which tools are currently being shared or used by another user and which tools are available for sharing; (v) the ability to specify which tools or groups of tools are visible and offered for sharing to the tool owner's connections and the ability to classify or designate different types of connections—each having different accessibility and visibility into the tool owner's inventory; (vi) the ability to keep tool inventory (or portions thereof) invisible to the public; (vii) a workflow for borrowing/loaning tools, which enables a tool owner to specify tools available for loan to any borrower in the tool owner's network but with specific loan conditions or requirements that must be accepted by the borrower before the tool is loaned out and that enables a borrower to request a tool with conditions or requirements presented by the borrower, which the tool owner can accept or reject before the tool is loaned out and marked as such within the system; further, the workflow for borrowing/loaning tools preferable enables the borrower to return (check-in) a tool, which the owner must “accept” for the status of the tool to change to “available,” and enables the owner to check-in a returned tool with no action required by the borrower; (viii) the ability to use push and in-app notifications when a connection is requested or status changes for borrowing/loaning tools; (ix) the ability to indicate that a particular tool is part of the tool inventory but to show that it is currently “on loan” or unavailable to be borrowed—with an expected “return” date shown for the tool if the loan duration was specified at the time it was borrowed; (x) the ability to search for any tool in the database among a group of connections (and with an indication of the degree of separation—if the searcher is not directly connected with the tool owner); (xi) the ability to search for a tool by manufacturer, category, status, connection, custom field or any other text string of any word in the tool record (e.g., a search for “nail” would return any tool record that contains the term “nail).

Preferably, the enterprise version of the application includes the following functionality and features: (i) the ability to add rental tools to the tool catalog—with rental rate, date due back and push notifications for reminders; (ii) the ability to have peer-to-peer (i.e., employee-to-employee) transfer of tools. For example, the consumer version of the application preferably requires that any loan of a tool go through the tool owner rather than enabling connections/friends/relatives/neighbors of the tool owner to pass the loaned tool around directly. The reason for this is to preserve the privacy of a tool owner's connections. In other words, with the consumer version of the application, a tool has to be checked back in to the owner and then checked back out to another connection. In the consumer version, if individual A is connected to individual B and individual B is connected to individual C and has loaned a tool to individual C, individual A is able to “see” that individual B has the desired tool, but that it is currently unavailable for loan. Individual A cannot see which of individual B's connections actually has the tool. Obviously, individual users can specify the level of privacy desired and enable their tool inventory or current loan status to be viewable beyond one degree of separation, but the default privacy setting only allows individuals to see available tools with their direct (1 degree of separation) connections. In contrast, the enterprise version will preferably enable and encourage the transfer of tools between anyone connected to the tool owner (i.e., by and among employees of the enterprise tool owner).

Optionally, the enterprise version of the application can make effective use of bar coding of tools or RFID to streamline the check-in, check-out, and “in the field” transfer from one borrower to another without need for a centralized check-in or check-out process.

In additional aspects of the present invention, the peer-to-peer sharing platform provides a master catalog of tools that can be searched by a network of connected users. Preferably, color-coding can be used by the application user interface to enable a user to quickly determine the status of a particular tool. For example, tools are preferably displayed to an end user via a tool view screen, a tool detail screen, a search screen, and a connection's tools screen. A tool icon is shown on all views within a color-coded circle designating a tool's status as follows:

Yellow—Available tools owned by the current user;

Grey—Unavailable tools from other connections OR the current user's tools marked as non-sharable or unavailable;

Blue—Available tools from other connections;

Red—Borrowed tools by the current user; and

Green—Loaned tools by the current user.

Obviously, the above colors are merely exemplary—any color scheme can be chosen to indicate one of the above-designated statuses or to indicate additional statuses beyond what is listed above. Further, additional colors or display indicators (e.g., blinking circle to indicate tool due for return or overdue for return, circle with two levels of thickness to indicate the length of time the tool has been on loan or to indicate when the tool is expected to be returned, and the like) can also be used to provide additional information about the tool, its status, who has it, where it is (e.g., proximity to the current user), etc.

The application is preferably designed to force acknowledgement between the borrower and tool owner whenever a tool is borrowed or available for loan. A “Borrow Use Case Model” workflow and a “Loan Use Case Model” workflow are illustrated in the attached figures.

Preferably, a tool owner's connections will not be able to “see” each other unless they are also connected. In the enterprise version, connections are usually employees and, as such, are automatically connected to each other with respect to the tool inventory of the enterprise with which they are employed. There is a setting in the enterprise version that allows sharing of tools between connections so tools marked unavailable will: (a) display who has the tool; and (b) allow the transfer of tools directly between connections without requiring the tool owner's approval, thus improving the efficiency of field tool management. A “Transfer Use Case Model” workflow is illustrated in the attached figures.

A “Return Tool Use Case Model” workflow is also illustrated in the attached figures, which addresses when a tool is returned to the tool owner after being borrowed or loaned out.

Preferably, the application enables selective sharing. Tool records can be marked as: (a) Sharable—will display with a blue icon to connections if available, gray if unavailable; (b) Non-sharable (or private)—will not display to connections; or (c) Selective—the user selects which connections can see the item.

Preferably, the application also includes a tool wiki, which provides a web-based, community-maintained library of all tools identified by users. Features include: the same tool record structure as the application itself (i.e., title, description, manufacturer, model number, etc.) and user ratings and reviews.

The tool wiki enables the application to search the master database of all tools identified and added to the system by users so that, when a user enters a new tool in their personal library, the system will check to see if the tool already exists in the wiki. If the tool exists, the user will be prompted to copy the tool information from the wiki, simplifying the setup process and encouraging uniformity of tool naming and descriptions within the universe of users of the application.

In a first aspect, a system for sharing and tracking tools among a plurality of users in the field without need of a centralized tool repository from which tools are physically loaned out and checked back in upon return is disclosed. The plurality of users includes a tool owner and a plurality of connections of the tool owner, wherein each of the plurality of users has at least one mobile device in electronic communication with a remote management server, the remote management server and each mobile device having a respective at least one processor, memory storage, and a non-transitory computer-readable medium that is usable by the at least one processor and is operatively coupled to the memory storage, storing a user record for each respective user and storing a tool record for one or more tools owned by the tool owner in the memory storage of the remote management server, each user record including a unique user ID and identification of the one or more mobile devices associated with each respective user, each tool record including a unique tool ID associated with each respective tool, each tool record further including the unique user ID of a first user currently in physical possession of the respective tool, the computer-readable medium having stored thereon a sequence of instructions that when executed by the at least one processor causes the remote management server and the mobile devices to perform one or more predetermined actions. The one or more actions performed by the system includes receiving a call to action from a requesting mobile device to update physical possession of a specific tool from the first user to a second user as reflected in the tool record associated with the specific tool maintained in the memory storage of the remote management server; determining the user ID of the requesting user based on the mobile device from which the call to action is received; determining the user ID of the first user based on the tool record associated with the specific tool; presenting to the requesting user on the requesting mobile device one or more actions that can be selected by the requesting user on the requesting device based on the call to action and based on the user IDs of the requesting user, the first user, and the second user; receiving the selected action on the requesting device; after physical receipt of the specific tool by the second user, receiving confirming of receipt of the specific tool on the mobile device of the second user; and in response to receiving the confirmation of physical receipt of the specific tool, updating current physical possession of the specific tool from the first user to the second user in the tool record of the specific tool.

In a feature, the first user and the second user are connections of the tool owner.

In one embodiment, the requesting user is the first user and the selected action comprises sending an offer to the mobile device of the second user for the second user to accept physical transfer of the specific tool, and wherein receiving confirmation of receipt of the specific tool on the mobile device of the second user comprises acceptance of the offer by the second user. Preferably, the offer includes a due date by which the specific tool must be returned by the second user. Further, the offer also preferably indicates whether the specific tool must be returned directly to the tool owner or back to the first user by the due date and wherein the due date is added to the tool record of the specific tool.

In another embodiment, the requesting user is the second user and the selected action comprises sending a request to the mobile device of the first user for the first user to physically transfer the specific tool to the second user, and further comprising receiving an acceptance of the request by the first user on the mobile device of the first user. Preferably, the request includes a due date by which the second user agrees to return the specific tool. Further, the acceptance of the request preferably indicates whether the specific tool must be returned directly to the tool owner or back to the first user by the due date and wherein the due date is added to the tool record of the specific tool.

In another embodiment, the requesting user is both the first user and the tool owner, the second user is a connection of the tool owner, and the selected action comprises sending an offer to the mobile device of the second user for the second user to accept physical loan of the specific tool from the tool owner, and wherein receiving confirmation of receipt of the specific tool on the mobile device of the second user comprises acceptance of the offer by the second user. Preferably, the offer includes a due date by which the specific tool must be returned by the second user to the tool owner and wherein the due date is added to the tool record of the specific tool.

In yet a further embodiment, the requesting user is both the second user and the tool owner, the first user is a connection of the tool owner, and the selected action comprises sending a request to the mobile device of the first user for the first user to physically return the specific tool to the tool owner, and further comprising receiving an acceptance of the request by the first user on the mobile device of the first user. Preferably, the request includes a due date by which the second user agrees to return the specific tool and wherein the due date is added to the tool record of the specific tool.

In another embodiment, the requesting user is the tool owner, both the first user and the second user are connections of the tool owner, and the selected action comprises sending a request to the mobile device of the first user for the first user to physically transfer the specific tool to the second user and sending an offer to the mobile device of the second user for the second user to accept physical transfer of the specific tool from the first user, and further comprising receiving an acceptance of the request by the first user on the mobile device of the first user, and wherein receiving confirmation of receipt of the specific tool on the mobile device of the second user comprises acceptance of the offer by the second user.

In a feature, the specific tool is selected from a tool list displayed on the requesting mobile device. Preferably, the tool list identifies a status of each tool listed therein, wherein the status is chosen from one of the following: available for loan, already borrowed, and unavailable for loan. In a preferred embodiment, each respective status is associated with a respective color-coded indicator. In alternative embodiments, the specific tool is displayed on the requesting mobile device after the requesting user performs a search on the mobile device, after a bar code has been scanned from the specific tool, or after an RFID has been detected on the specific tool.

In yet a further feature, the specific tool is initially identified using a bar code or RFID reader in electronic communication with the requesting mobile device.

In another feature, the actions performed by the system include receiving a search request for the specific tool based on one or more search parameters specified on the requesting mobile device by the requesting user.

In a further feature, receiving the selected action is based on input received on the requesting mobile device from the requesting user.

Any process descriptions or blocks in flow charts should be understood as representing modules, segments, or portions of code, which include one or more executable instructions for implementing specific logical functions or steps in the process. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The present inventions also encompasses computer-readable media having computer-executable instructions for performing methods of the present invention, and computer networks and other systems that implement the methods of the present invention.

The above features as well as additional features and aspects of the present invention are disclosed herein and will become apparent from the following description of preferred embodiments of the present invention. It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims herein.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In addition, further features and benefits of the present technology will be apparent from a detailed description of preferred embodiments thereof taken in conjunction with the following drawings, wherein similar elements are referred to with similar reference numbers, and wherein:

FIG. 1 is a high level system view of the primary components of one embodiment of the present invention;

FIG. 2 is a schematic illustrating the multi-tenant design of the embodiment of FIG. 1;

FIGS. 3A-3J are exemplary screen shots from a mobile device being used in conjunction with the embodiment of FIG. 1;

FIGS. 4-7 illustrate various flow charts of the processes used by the system in accordance with the embodiment of FIG. 1, including methods for requesting to borrow a tool, for offering to loan out a tool, for returning or checking a tool back into a tool owner's inventory, and for transferring a tool from one borrower to another in the field; and

FIGS. 8-12 are exemplary screen shots from a web interface used by an Enterprise user or administrator used in conjunction with the embodiment of FIG. 1.

### DETAILED DESCRIPTION OF PREFERRED EMBODIMENTS

Before the present technologies, systems, products, articles of manufacture, apparatuses, and methods are disclosed and described in greater detail hereinafter, it is to be understood that the present technologies, systems, products, articles of manufacture, apparatuses, and methods are not limited to particular arrangements, specific components, or particular implementations. It is also to be understood that the terminology used herein is for the purpose of describing particular aspects and embodiments only and is not intended to be limiting.

As used in the specification and the appended claims, the singular forms “a,” “an” and “the” include plural referents unless the context clearly dictates otherwise. Similarly, “optional” or “optionally” means that the subsequently described event or circumstance may or may not occur, and the description includes instances in which the event or circumstance occurs and instances where it does not.

Throughout the description and claims of this specification, the word “comprise” and variations of the word, such as “comprising” and “comprises,” mean “including but not limited to,” and is not intended to exclude, for example, other components, integers, elements, features, or steps. “Exemplary” means “an example of” and is not necessarily intended to convey an indication of preferred or ideal embodiments. “Such as” is not used in a restrictive sense, but for explanatory purposes only.

Disclosed herein are components that can be used to perform the herein described technologies, systems, products, articles of manufacture, apparatuses, and methods. These and other components are disclosed herein, and it is understood that when combinations, subsets, interactions, groups, etc. of these components are disclosed that while specific reference to each various individual and collective combinations and permutation of these may not be explicitly disclosed, each is specifically contemplated and described herein, for all technologies, systems, products, articles of manufacture, apparatuses, and methods. This applies to all aspects of this specification including, but not limited to, steps in disclosed methods. Thus, if there are a variety of additional steps that can be performed, it is understood that each of the additional steps can be performed with any specific embodiment or combination of embodiments of the disclosed technologies, systems, products, articles of manufacture, apparatuses, and methods.

Further, as will be appreciated by one skilled in the art, embodiments of the present technologies, systems, products, articles of manufacture, apparatuses, and methods may be described below with reference to block diagrams and flowchart illustrations of methods, systems, processes, steps, and apparatuses. It will be understood that each block of the block diagrams and flow illustrations, respectively, support combinations of means for performing the specified functions and/or combinations of steps for performing the specified functions.

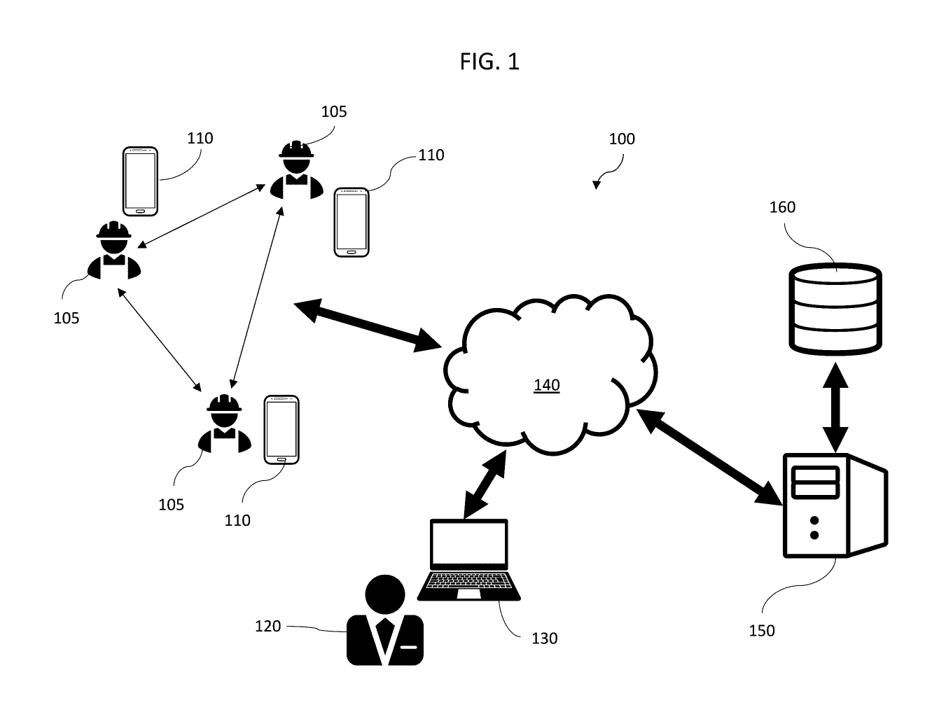

Turning now to the drawings, FIG. 1 illustrates a preferred tool tracking system 100 according to one preferred embodiment. The system 100 uses an N-Tier architectural framework to maintain separation of concerns for presentation, application processing and logic, and data persistence. The system 100 includes a plurality of field users 105 that interact with each other in the field and interact with the system website using their respective mobile devices 110. The system 100 further includes one or more administrative users 120 who use a computing device 130 to interact with the system website. The mobile devices 110 and computing device communicate in conventional manner through the Internet or other public or private communication network 140 with a system server 150, which has access to and stores data on one or more databases 160. Preferably, the system 100 is managed and controlled by an Infrastructure as a Service (IaaS), such as Microsoft Azure, that runs on the server 150 and includes an application layer that includes: a) web services, b) a business logic layer that includes an application logic layer, data model, infrastructure layer, and data access layer, and c) a data layer that includes a database server and content server for interacting and communicating with the system database 160. The application layer is responsible for processing services, enforcing business logic rules, authenticating users, authorizing account services for authenticated users, and managing user sessions.

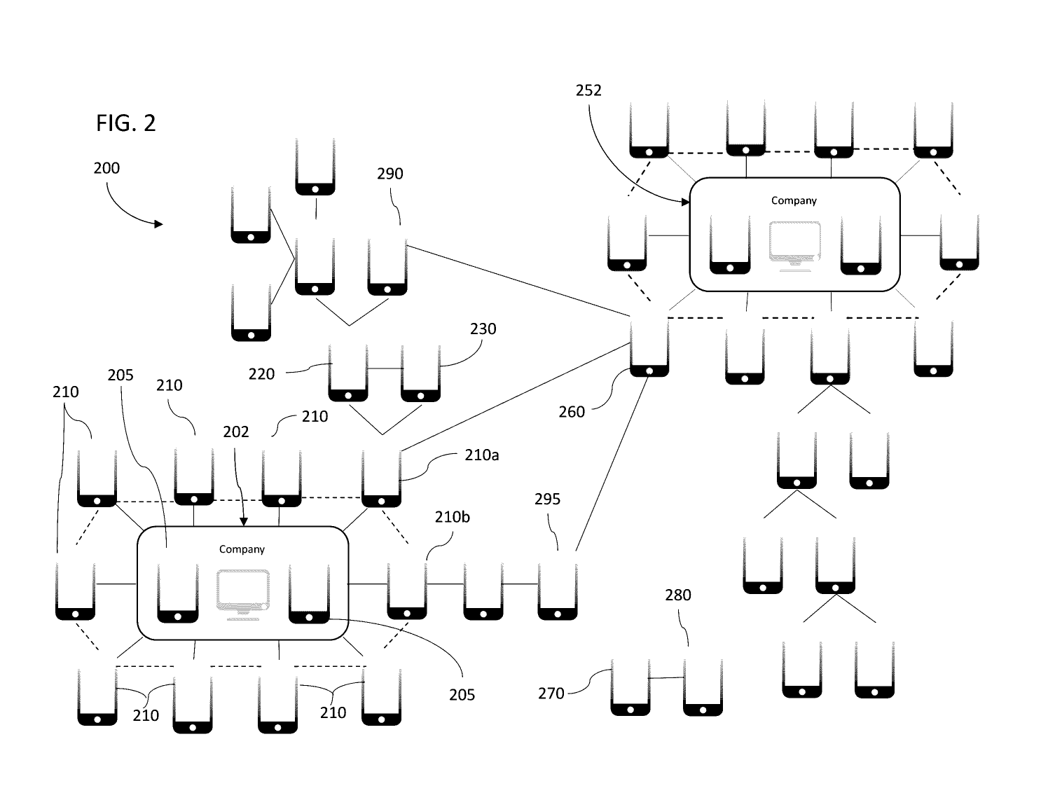

FIG. 2 is a schematic 200 of one exemplary multi-tenant sharing design used by the present system. The number of connections and relationships is infinitely variable—just like any social network of relationships. However, as will be understood, the present system is designed to handle personal connections, intra-employer (i.e., employee-to-employee within a company) connections, inter-employer (i.e., employee-to-employee between companies) connections, and any combinations of the above. For example, company 202 preferably has a database of tools accessed through one or more mobile devices and a web interface. In this exemplary illustration, company 202 has two (2) administrators 205 and ten (10) employee/users 210, illustrated by the ten mobile devices connected to each other indirectly (by dashed lines) and shown connected directly to the company 202 (by solid lines). In this example, user 210a has four direct connections: one with his employer/company 202, one with user 220, one with user 230, and one with user 260. As shown, users 220 and 230 are also connected directly to each other. In addition, user 260 is also an employee of employer/company 252, which has its own administrators and additional employees. User 260 also has a number of other direct non-employee connections 290, 295. User 270 and user 280 are individuals who are only connected to each other and are not shown as being affiliated with any specific employer/company; however, as will become readily apparent hereinafter, such users can ultimately end up connected to any other user within the network or system though an invitation.

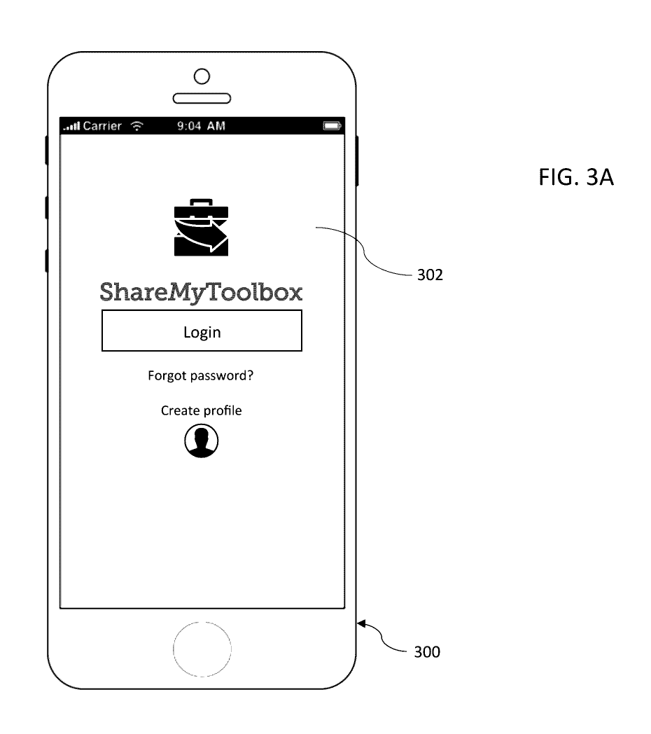

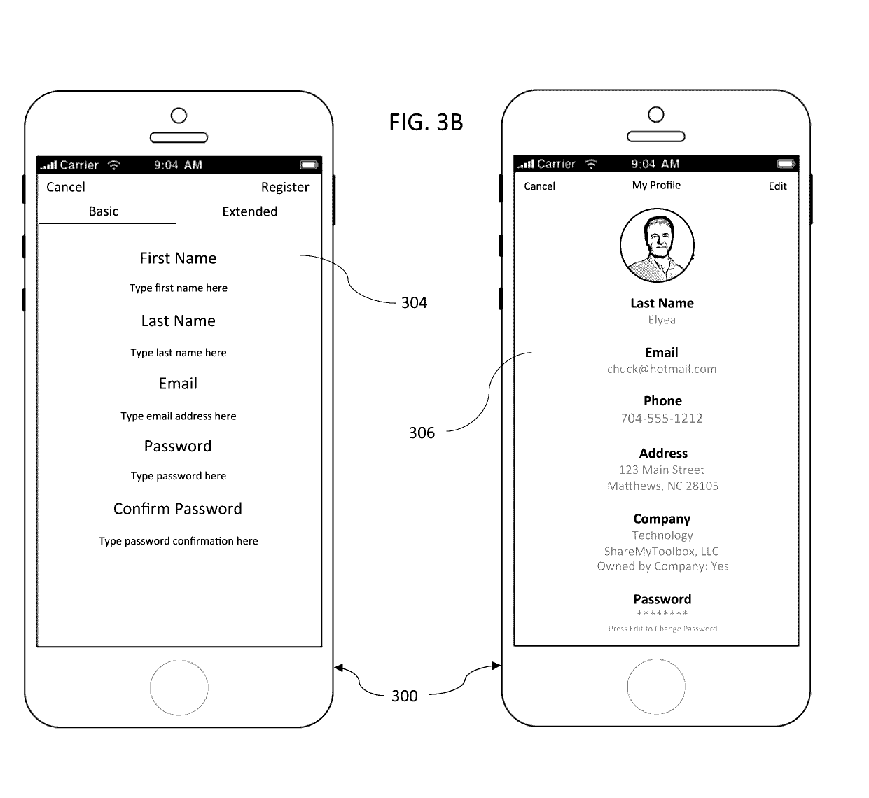

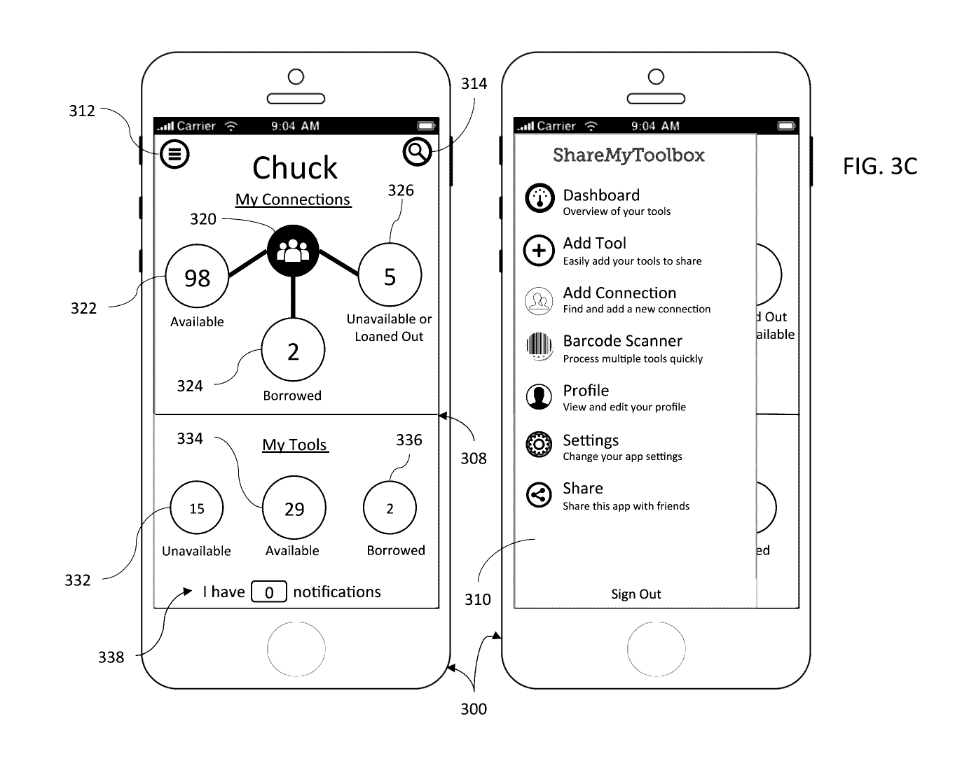

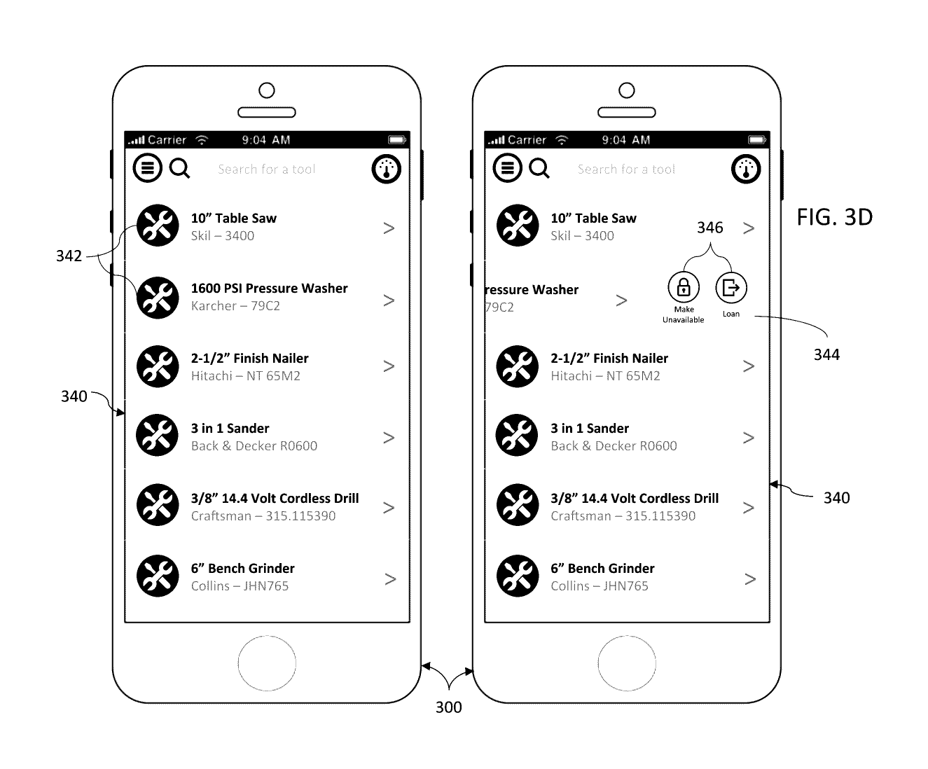

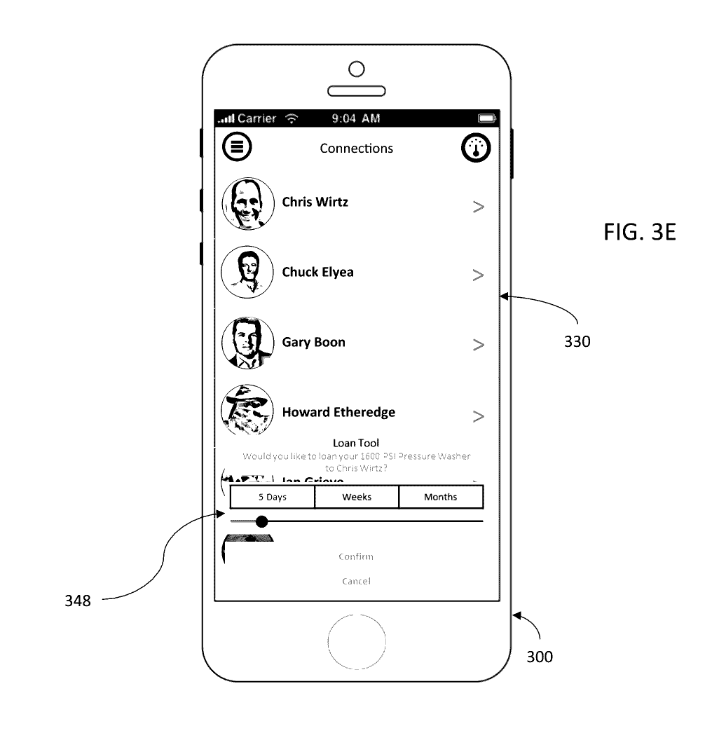

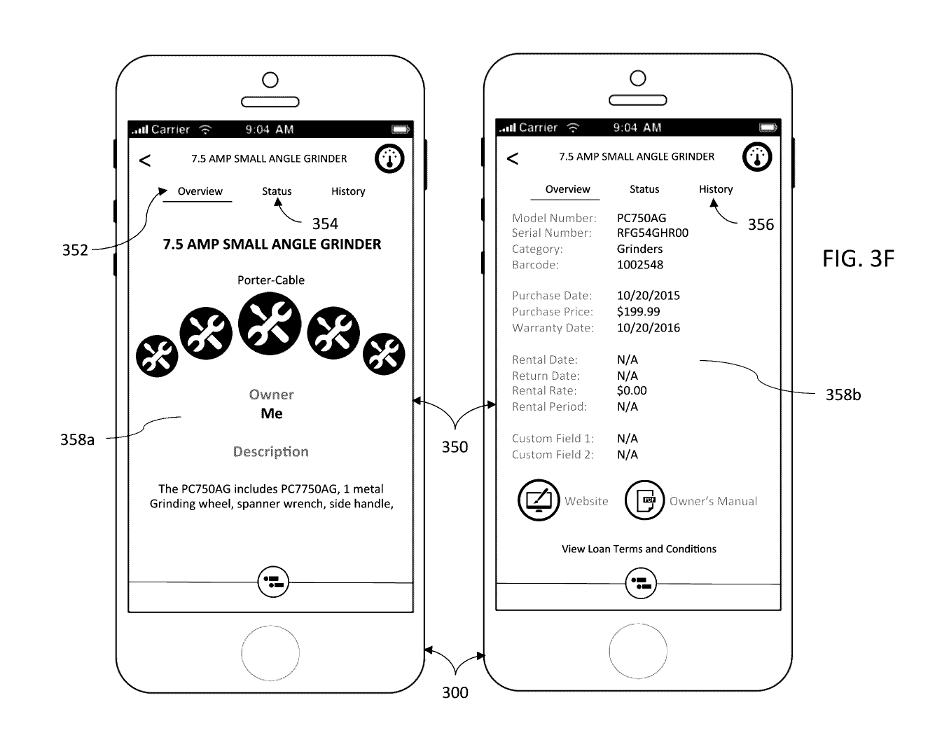

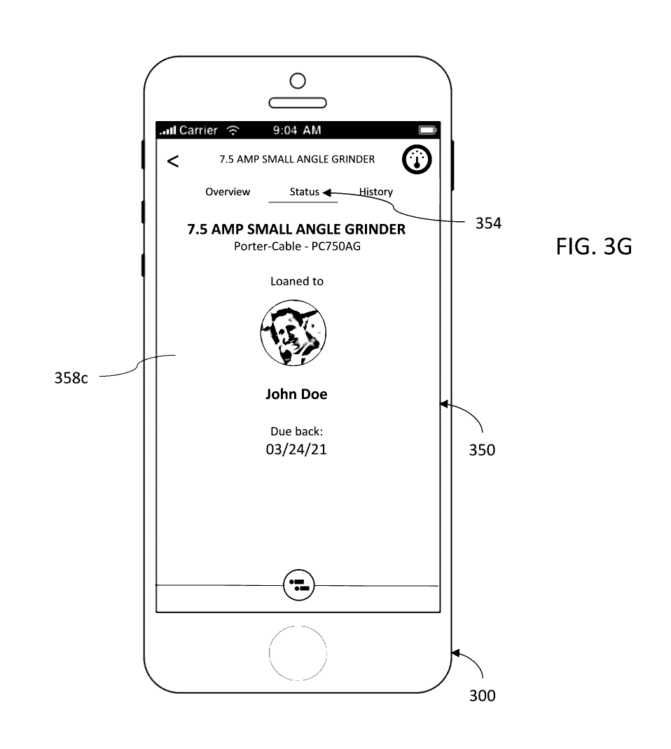

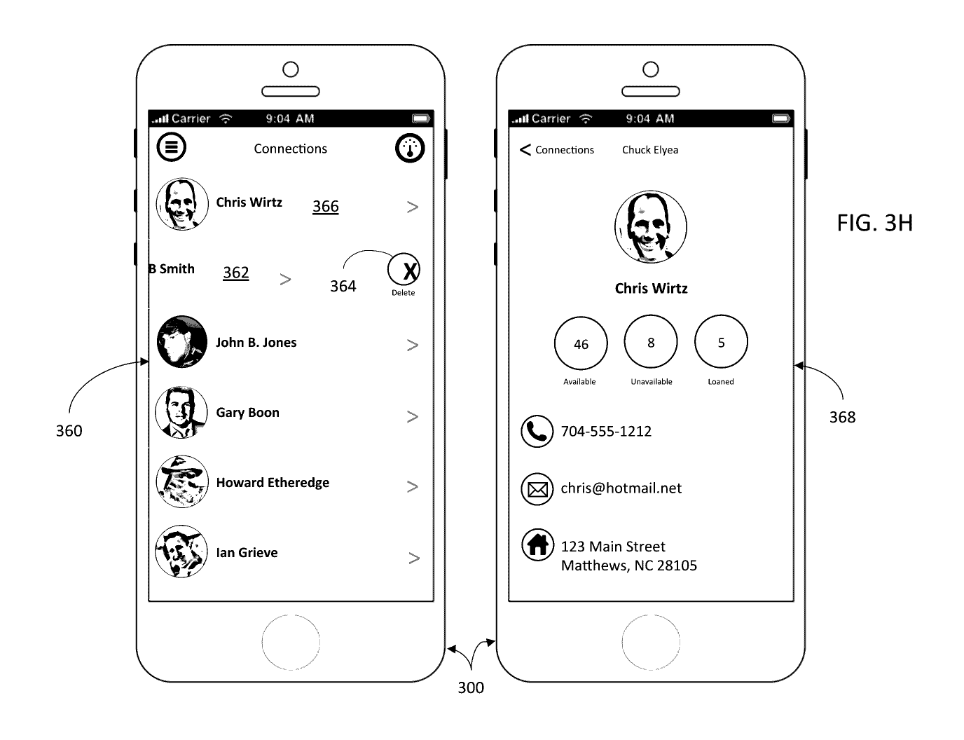

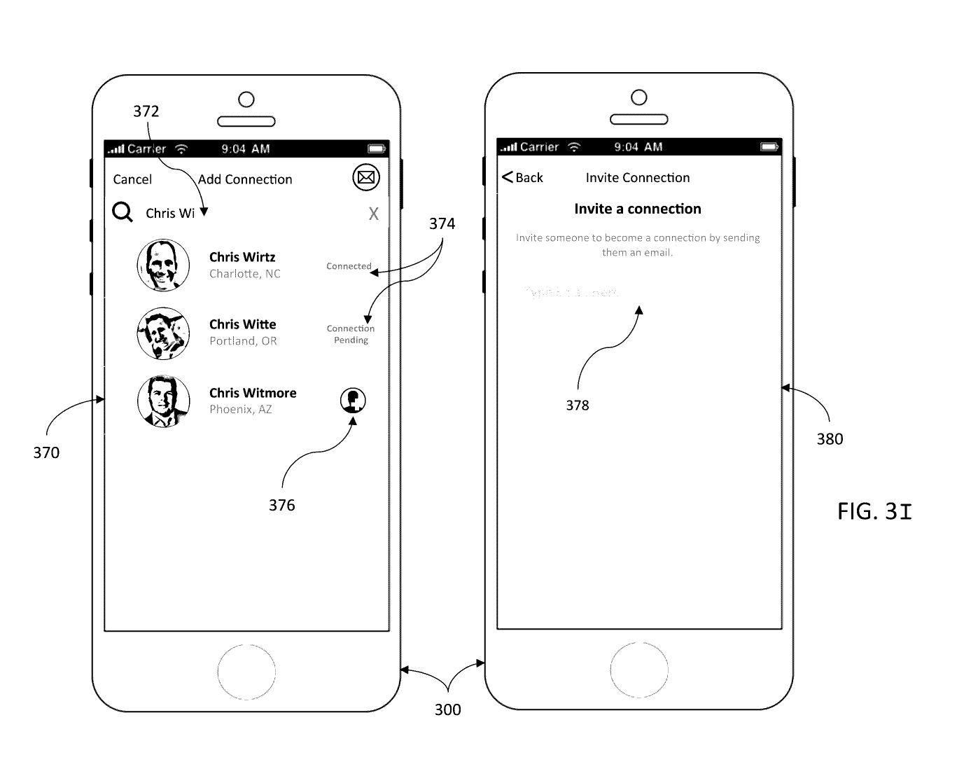

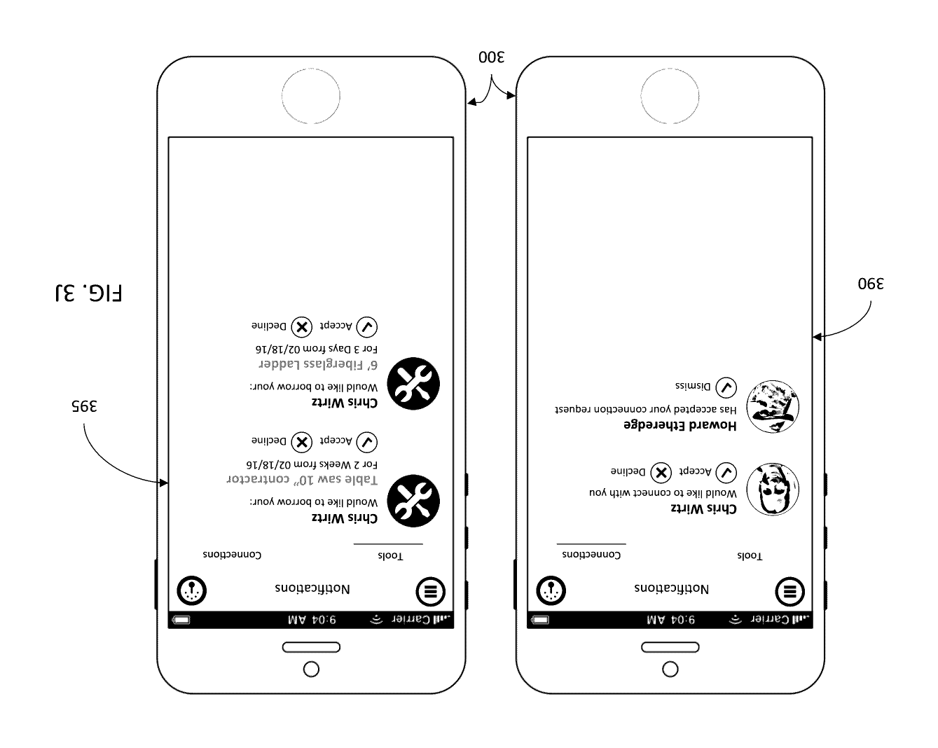

FIGS. 3A through 3J illustrate a plurality of exemplary user interface screen shots through which a user would typically navigate when using the system on a mobile device 300, as described herein. A conventional mobile login screen 302 is illustrated in FIG. 3A. From this login screen 302, users are able to log in if they have previously registered, create a user profile if they are new users, or request a password reset. If a new user wants to register, such new user is presented with a registration screen 304, as shown in FIG. 3B. A new user registers with basic information, such as first name, last name, email address, and password. Expanded registration is also available from the initial registration screen 304 or from the user's profile screen 306, which enables the user to add or change profile details, including but not limited to first name, last name, address(es), photo, phone number(s), company name, company type, position with the company, system display or notification preferences, and password. In preferred embodiments, the user's profile is associated with their email address, which cannot be changed. In alternative embodiments, the user can be assigned a non-changeable system userID, which then enables the user to add more than one email address and to update or delete old email addresses, as needed.

FIG. 3C illustrates an exemplary mobile “main” dashboard 308 and side menu 310, both of which are designed as the primary workflow interface by users within the system. As will become apparent hereinafter, the main dashboard 308 and side menu 310 provide a user with easy access to their tool and connection databases. The side menu 310 is accessible from the dashboard 308 and from most other screens within the system by pressing or otherwise selecting the menu icon 312. The side menu 310 provides quick access back to the dashboard 308, and further includes links for adding tools, adding connections, checking tools in/out via barcode, modifying the user's profile, modifying the user's system settings, sharing the app with co-workers or friends, and logging out of the application.

Turning back to the main dashboard 308, a user is able to perform a global tool search among the network of the user's connections by pressing or otherwise selecting the search icon 314. The main dashboard 308 is divided into two main sections. The top section provides the user with a tool status overview for the user's connections. The bottom section provides the user with a tool status overview for the user's own tools. In some embodiments, the specific details provided in the user's high level connection list and tools list can be customized by the user in the user's settings.

In the top section of the dashboard 308, the connection icon 320 connects to three different icons that display the number of tools available, borrowed, and unavailable within the user's network of connections. For example, an available icon 322 is preferably colored blue, displays a count of tools that are available within the user's network, and when pressed or otherwise selected opens a new window or screen that displays a specific list of such available tools with the corresponding status (as will be described in greater detail hereinafter in association with FIG. 3D). A borrowed icon 324 is preferably colored red, displays a count of tools within the user's network that have been borrowed by the current user, and when pressed or otherwise selected opens a new window or screen that displays a specific list of such borrowed tools with the corresponding status. An unavailable icon 326 is preferably colored gray, displays a count of tools that are unavailable or already loaned out to someone else within the user's network, and when pressed or otherwise selected opens a new window or screen that displays a specific list of such unavailable tools with the corresponding status. In this example, there are 98 available tools, 2 tools already borrowed by the user, and 5 tools unavailable (or already on loan to someone else) within the user's network of connections.

In some embodiments, by pressing or selecting the connection icon 320, a new window or screen opens that displays a list of all tools within the user's network for all categories of tool statuses. In other embodiments, the connection icon 320 can be used to toggle through different categories of connections established by the user. For example, one setting of connections identifies all connections in the user's network, another setting just shows enterprise/co-employee connections, and another just shows personal or non-enterprise connections. The number of tools available, borrowed, and unavailable within the user's network of connections displayed will change based on the category of connections selected. The ability to switch between connection categories is helpful, for example, when an employee is “on the job” and needs to search and view connections and tools only from co-workers. In contrast, when the user is at home working on a personal project, the user may want to view or search through all connections or just within his network of neighborhood or personal connections.

In the bottom section of the dashboard 308, the tool status overview displays the number of tools of the user that are unavailable, available, and already loaned out within the user's network of connections. The unavailable icon 332 is preferably colored gray, displays a count of the current user's tools that have been added to the user's tool database but marked by the current user as currently unavailable or non-shareable, and when pressed or otherwise selected opens a new window or screen that displays a specific list of such unavailable tools with the corresponding status. The available icon 334 is preferably colored yellow, displays a count of the current user's tools that are available for loan, and when pressed or otherwise selected opens a new window or screen that displays a specific list of such available tools with the corresponding status. The loaned out or borrowed icon 336 is preferably colored green, displays a count of the current user's tools that are loaned out to one of the user's connections, and when pressed or otherwise selected opens a new window or screen that displays a specific list of such loaned out tools with the corresponding status. In this example, the system illustrates that the current user personally has 29 available tools, 2 borrowed tools, and 15 unavailable tools being monitored and managed within the system. Finally, the number of outstanding notifications 338, if any, displays to the current user on the main dashboard 308 and indicates whether there have been any connection or tool requests (or other status updates or changes) and, when pressed or otherwise selected, displays a list of such requests and other notifications.

FIG. 3D illustrates the tool list and status screen 340 that lists available, borrowed, or unavailable tools whenever one of the numbered, colored status icons 322, 324, 326, 332, 334, or 336, shown in FIG. 3C, is pressed or otherwise selected from the main dashboard 308. Preferably, a color-coded circle around the tool thumbnail 342 matches the color-coding used for the icons on the main dashboard 308 to indicate each tool's status. For example, blue is indicative of a connection's available tool, yellow indicates an available tool of the current user, red indicates a tool borrowed by the current user from a connection, green indicates one of the current user's tools that has been loaned out to a connection, and gray indicates an unavailable tool, whether a tool of the current user or of one of the user's connections. By “swiping left” on a specific one of the tool panels 344 from the list screen 340, the user is presented with action item buttons 346 indicating actions that can be taken by the user with respect to that tool. The specific actions that can be taken depend on the current status of that tool. The following table illustrates this concept.

| Tool Status | Color Code | Available Actions |
|---|---|---|
| Available-My Tools | Yellow | Make Unavailable, Loan |
| Available-My Connections | Blue | Borrow |
| Borrowed-My Connections | Red | Check In, Transfer |
| Unavailable-My Connections | Gray | Transfer |
| Unavailable-My Tools | Gray | Make Available, Loan |
| Loaned-My Tools | Green | Check In, Transfer |

For example, as shown in the above table, if the tool belongs to the user and is currently available for loan (indicated by a yellow icon), after swiping left on the tool, the user is then able to select one of the icons 346 either to make the tool unavailable or to loan that tool to one of the user's connections. If the tool belongs to a connection within the user's network and is available (indicated by a blue icon), then the user can request to borrow that tool. “Check-in” means that a borrowed tool is being returned to the tool owner. “Transfer” means that a borrowed tool is being transferred from one borrower to another.

As shown in FIG. 3E, if the user selects to loan out or borrow a specific tool using one of the action item icons or buttons 346 from FIG. 3D, a connection list 330 is displayed. The user is able to select one of the connections from the list, which opens a dialog box 348. The dialog box 348 identifies the connection, the tool selected, and whether the tool is being borrowed or loaned out. In addition, the user is able to indicate the loan or borrow duration in days, weeks, or months, and then confirm or cancel the transaction.

FIGS. 3F and 3G illustrate the tool detail screen 350 that displays when the user selects a tool from the tool list and status screen 340. The tool detail screen 350 includes an overview tab 352, a status tab 354, and a history tab 356. The tool detail screen defaults to its “overview” page 358a, which is also displayed whenever the user specifically selects the overview tab 352. The overview screen 358a for the tool includes the tool title, manufacturer, one or more picture thumbnails that jump to full screen images (if available), tool owner, and a detailed description that expands to a full page view 358b or, in the alternative, is viewable by scrolling up on the overview page 358a. The detailed description 358b includes additional information about the selected tool, such as but not limited to model number, serial number, a user-defined category, barcode number, purchase date, purchase price, warranty date, rental date, rental rate, rental period, and one or more custom fields that can be defined by the user, URL link to the manufacturer's website, and URL link to the owner's manual, and a tab that will open a new window or box that includes the loan terms and conditions, if any, associated with the tool. As shown in FIG. 3G, when the status tab 354 is selected, the tool status screen 358c displays additional information about who currently has the tool and, if it has been loaned out, the date it is due for return. By selecting the history tab 356, a screen (not shown) is opened that provides a history of the tool status from the time the tool database record was first created up to the present—with a history of who borrowed the tool shown by date. IN some embodiments, the history details can be sorted by borrower, by chronological or reverse chronological date, or by any other parameter (e.g. loan duration, rental fees collected, etc.) tracked by the system.

FIG. 3H illustrates the connection list 360 that displays when the connection icon is pressed on the dashboard 308. Swiping left on a specific connection panel 362 displays the option 364 to delete the connection—assuming that no tools are currently outstanding (in either direction) with that connection. Selecting a specific connection 366 from the connection list 360 displays a connection detail display 368 with a photo, phone number, email address, mailing address, and tool icons. The tool icons are color-coded identical to the main dashboard 308 with available tools-blue, unavailable-gray, and loaned-green. The tool icons also display the number of tools corresponding to that status and, when the user presses or otherwise selects one of the icons, the system displays the tool list and status screen 340, as previously described in conjunction with FIG. 3D.

FIG. 3I illustrates the add connection screen 370, which is launched from the add connection icon on the side menu 310 (shown in FIG. 3C) and which enables a user to add new connections. The user can search for potential connections using the search bar 372. Connections and potential connections matching the search criteria, to the extent entered, are listed below the search bar 372. The connection status 374 of each connection or potential connection is also shown, such status indicating who is already a connection, who is a pending connection (invitation previously sent, but not accepted), or who is available to connect. Preferably, the search results not only include individuals who are registered within the system, but also individuals within the address book of the user accessible on the user's mobile device. By pressing or otherwise selecting the add new connection icon 376, the user is able to send an invitation to connect to a registered user of the system. If the potential connection is not already a registered user within the system, an invitation screen 380 is opened, which enables the user to send an invite by email to the email address entered into field 378.

FIG. 3J illustrates notification screens 390, 395 that are displayed when the user desires to review the status of any connection requests or requested change of status for any tool being loaned out, borrowed, returned, or transferred between users. Specifically, notification screen 390 illustrates the status of various connection requests. Depending on the type of notification, the user is given the option to select icons to accept or reject a connection request, withdraw a previous connection request that has not been answered, and to dismiss a notification confirming acceptance or rejection of a prior request sent out by the user. Notification screen 395 shows the status of any requests to borrow or loan out a tool or to transfer it between users in the field.

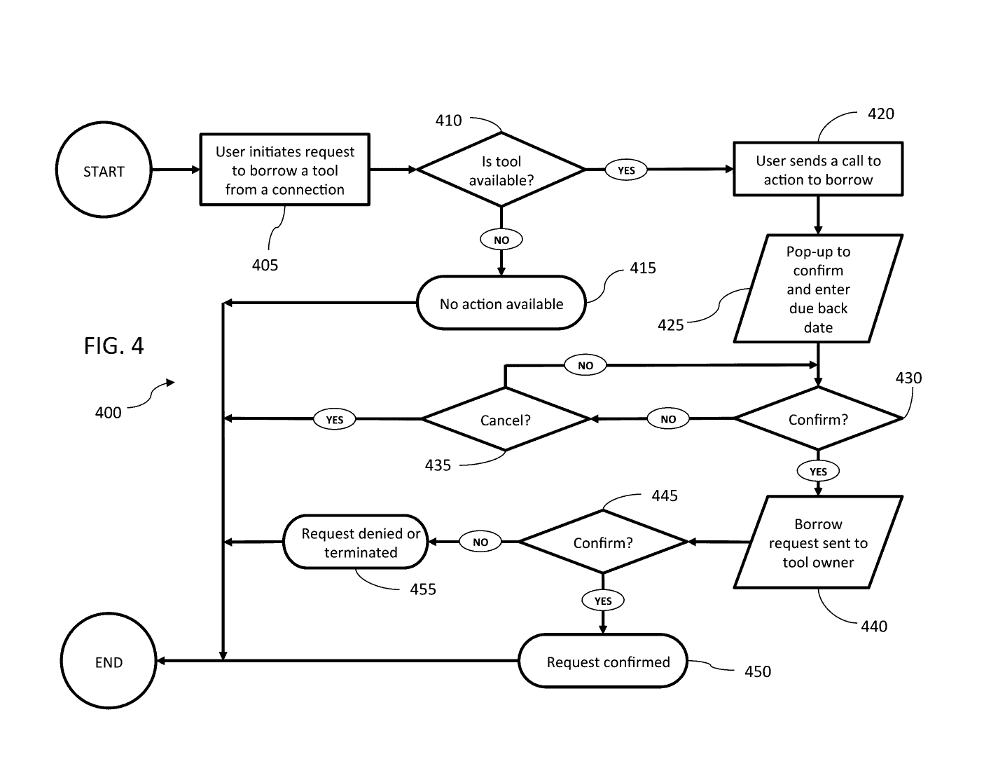

Turning now to FIGS. 4-7, various processes performed by the system described herein and according to preferred embodiments of the invention are illustrated.

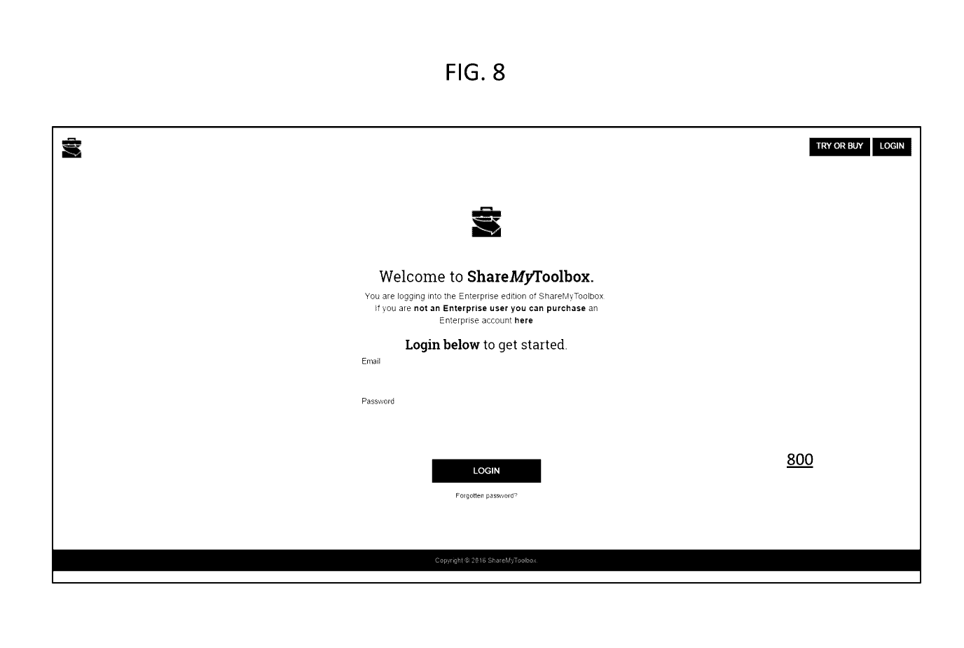

FIG. 4 illustrates a preferred “borrow tool” process 400 performed by the system when a user wants to borrow a tool from a connection. As will be appreciated from a review of the mobile screen shots of FIGS. 3A-3J, a user initiates (step 405) this borrow tool process 400 from any number of mobile views, including the tool list view, tool detail view, search results view, and the connections' list view. Based on the tool requested, tool availability is first determined (step 410). If the tool is not available or is already loaned out to another connection or other 3^{rd} party, the tool cannot be borrowed, no action is available (step 415), and the process ends. In an alternative embodiment (described in greater detail in association with FIG. 8), typically available in an enterprise or upgraded version of the system, the user can request a tool transfer directly from the current user who has the tool out on loan. If the tool is available, a borrow call to action is initiated (step 420). As described previously, the user presses or selects the borrow icon and a pop-up dialog box displays (step 425), which enables the user to verify that the correct tool is being requested and enables the user to enter a proposed return date for the tool being borrowed. If the user does not confirm the transaction (step 430), the system determines whether the user has cancelled the transaction (step 435). If the user cancels the transaction, the process ends, and the user returns to the view from which the transaction originated. If the user does not cancel the transaction, the system continues to wait for the user to either confirm or cancel the transaction. If the user confirms the transaction, a borrow request notification is sent to the tool owner (step 440). The user receives a “pending” borrow tool notification and is able to continue using the application for other purposes. The tool owner receives a borrow tool request from the system and either confirms or denies the request (step 445). If the tool owner confirms the request, the tool status changes to loaned for the tool owner, borrowed for the borrower, and unavailable for other connections, and the borrower receives a confirmation that the request was accepted (step 450). If the tool owner denies or does not confirm the request (preferably within a predetermined period of time set by default by the system, set at a default by the user, or set by the user to a specific period associated with this specific request), the borrower receives a rejection or borrow request expiration notification (step 455) and the process 400 is terminated.

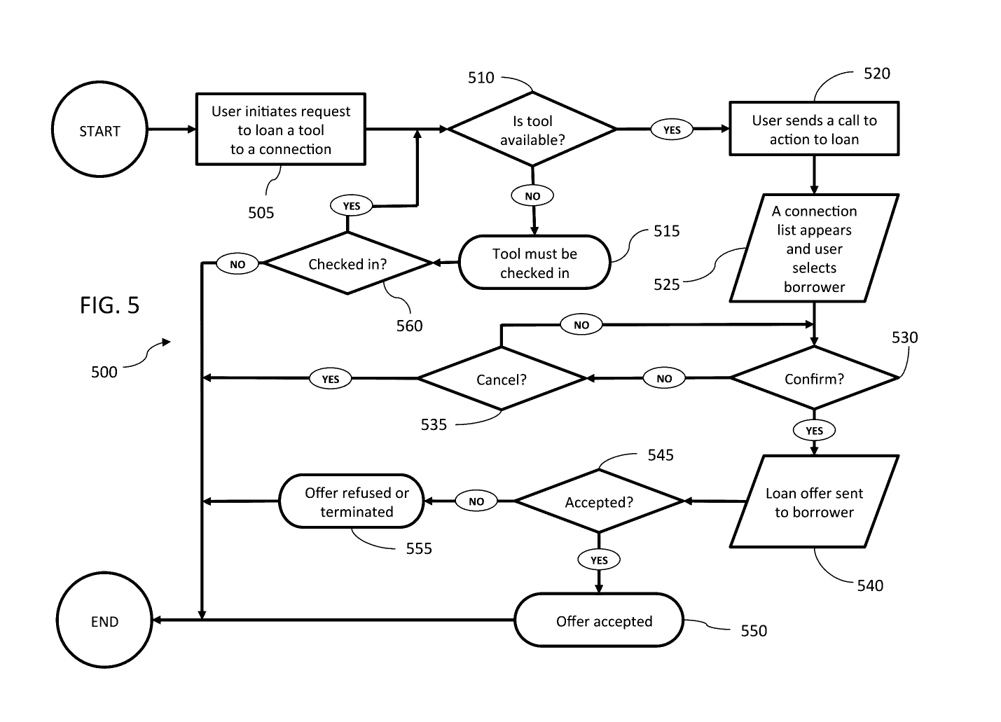

FIG. 5 illustrates a preferred “loan tool” process 500 performed by the system when a user wants to loan a tool to a connection. As will be appreciated from a review of the mobile screen shots of FIGS. 3A-3J, a user initiates (step 505) this loan tool process 500 from any number of mobile views, including the tool list view, tool detail view, search results view, and the connections' list view. Based on the tool requested, tool availability is first determined (step 510). If the tool is not available or is already loaned out to another connection, the tool cannot be loaned until it has been returned to the user and checked back in (step 515). The system then waits a predetermined period of time to determine if the tool has been checked back in (step 560). If so, the process returns to the tool availability determination (step 510). If the tool is not checked in within a predetermined period of time or if the user moves on to a different action unrelated to the loan tool process, the loan tool process just terminates. In an alternative embodiment (described in greater detail in association with FIG. 8), typically available in an enterprise or upgraded version of the system, the user can request a tool transfer from the connection that currently has the tool on loan to the connection to whom the owner wants to loan the tool. If (or once) the tool is available, a loan call to action is initiated (step 520). The tool owner/user presses or selects the loan icon and a connection list is displayed to the user, who is able to verify that the correct tool has been selected, is able to select a proposed borrower, and enter a due date by which the loaned out tool must be returned (step 525). If the user does not confirm the transaction (step 530), the system determines whether the user has cancelled the transaction (step 535). If the user cancels the transaction, the process ends, and the user returns to the view from which the transaction originated. If the user does not cancel the transaction, the system continues to wait for the user to either confirm or cancel the transaction. If the user confirms the transaction, a loan offer notification is sent to the proposed borrower (step 540). The user receives a “pending” loan tool notification and is able to continue using the application for other purposes. The proposed borrowed receives a loan tool offer from the system and either accepts or denies the request (step 545). If the proposed borrower accepts the loan offer, the tool status changes to loaned for the tool owner, borrowed for the borrower, and unavailable for other connections, and the tool owner/user receives a confirmation that the loan offer was accepted (step 550). If the proposed borrower rejects or does not accept the loan offer (preferably within a predetermined period of time set by default by the system, set at a default by the user, or set by the user to a specific period associated with this specific offer), the user receives a rejection or loan offer expiration notification (step 555) and the process 500 is terminated.

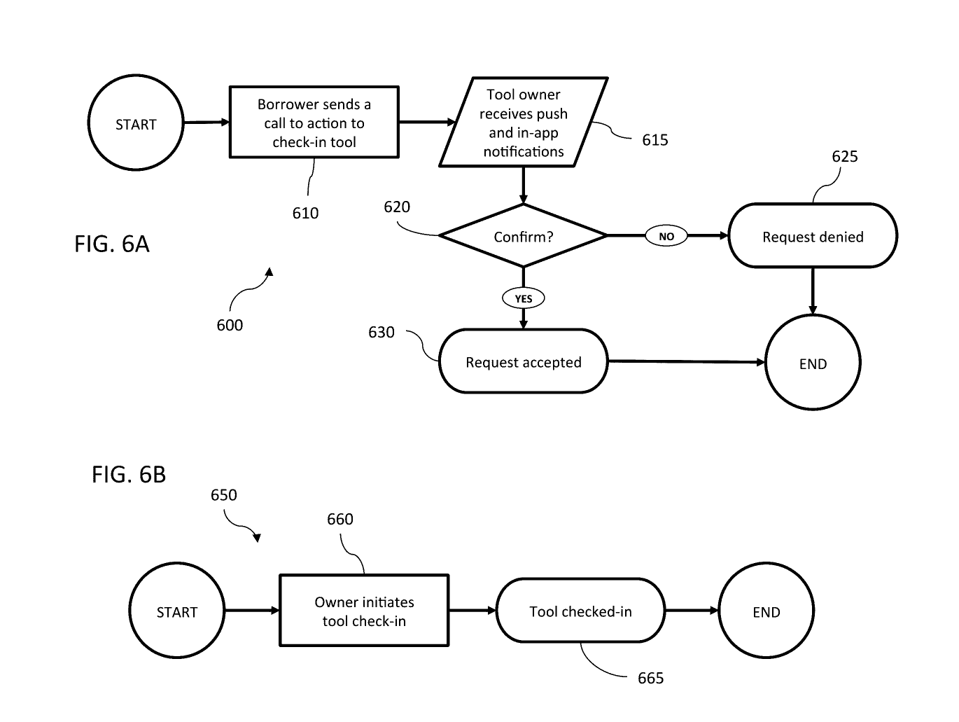

FIGS. 6A and 6B illustrate two preferred “loan return” and “check in” processes 600, 650, respectively, performed by the system. The loan return process 600 shown in FIG. 6A illustrates the steps performed when a borrower decides to return a tool back to its owner. Specifically, when the borrower decides to return the tool, the borrower initiates the process by sending a call to action (step 610) requesting that the tool owner receive the tool back and check it back in within the system. The call to action is initiated and sent by the borrower from any of a plurality of mobile views, including but not limited to the tool list view, tool detail view, search results screen, the notification screen, and the connection list. After the request to return the tool is submitted, the tool owner receives a notification (step 615) that the borrower wishes to check in a tool. The notification will be shown on the user's notification list and, optionally, depending on system and/or user settings, may also be received as a push notification on the user's mobile device. The system then determines (step 620) whether the tool owner accepts or rejects the check in request. If the owner denies the request (step 625), the process terminates and the borrower receives a notification that the request was denied and the process ends. If the owner accepts the request to check in a tool (step 630), the tool status changes to available, the borrower receives a return acceptance notification, and the process ends. The tool owner-initiated check in process 650 shown in FIG. 6B illustrates the steps performed when a tool owner decides to check in a tool. Such a process would likely be taken when the tool owner physically receives a tool that had been borrowed but does not receive (or has not yet received) a request initiated from the borrower to acknowledge return of the tool. The tool owner initiates a tool check in (step 660) from any of a plurality of mobile views, including but not limited to the tool list view, tool detail view, search results screen, the notification screen, and the connection list. The tool owner sends a call to action to check in the tool (step 655), which returns the tool to the list of available tools and causes the borrower to receive a notification confirming that the tool was checked in. An acceptance is not required from the borrower.

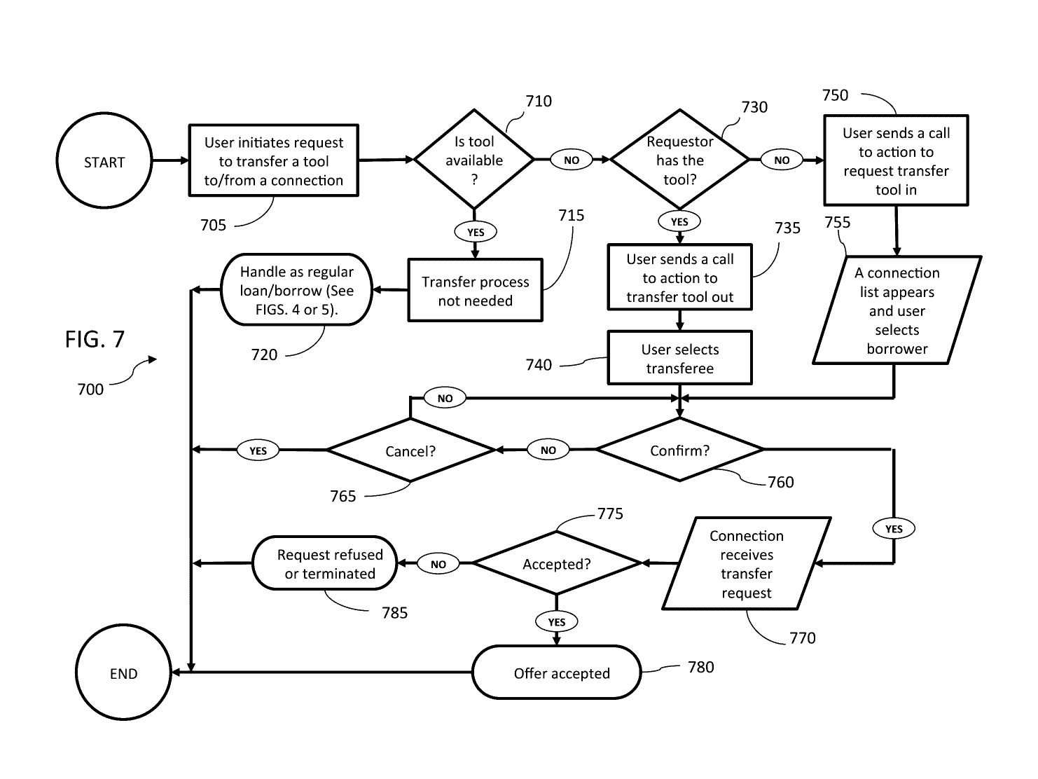

FIG. 7 illustrates a preferred process 700 for enabling a tool to be transferred from one borrower to another in the field and without requiring the tool first to be returned to or checked back in by the tool owner. Preferably, such connection-to-connection transfer is provided to Enterprise-based tool owners to enable a company's employees to share their employer's tools more easily and readily in the field and without requiring the tool to be returned to a central tool repository before it can be borrowed again by a different employee. In addition, such transfer process enables the tool to be tracked among employees while in the field in contrast with conventional practice in which the employer and employees who may need a tool are unable to determine, in real time, which employee currently has the tool. Such transfer process 700 may also be made available to individual tool owners, but will likely be of greater value to enterprise users who have multiple employees in the field who need to have access to shared company-owned tools.

The transfer process 700 can be initiated (step 705) by any of the three main users associated with such a transaction: the tool owner, the current borrower/transferor, or the intended borrower/transferee. Any one of these parties, a user, can initiate the process from any number of mobile views, including the tool list view, tool detail view, search results screen, and connection tool list view. Tool availability determines which action items are available (step 710). If the tool is available (i.e., not currently loaned out to a connection), the tool transfer process is not needed (step 715) and the tool can be borrowed or loaned out (step 720) using either the “borrow tool” process 400 described in association with FIG. 4 or the “loan tool” process 500 described in association with FIG. 5. Thus, the transfer process ends if the tool is available for loan from the tool owner.

If the tool is not available for loan from the tool owner (i.e., is currently loaned out to a connection), then the system determines (step 730) whether the person initiating the request is coming from the user who currently has possession of the tool (other than a scenario in which the tool owner has possession—which was already addressed by the tool availability determination at step 710).

If the user is the current borrower who wants to transfer the tool to another user/proposed borrower (other than back to the tool owner, which is considered a “check in” rather than a transfer), the user sends a call to action to transfer the tool out to the proposed new borrower (step 735). The user presses or selects the transfer icon and a connection list is displayed to the user, who is able to verify that the correct tool has been selected and then to select a proposed borrower to receive the transferred tool (step 740).

If the user is the proposed borrower who wants to have the tool transferred over from the current borrower, the user sends a call to action to request transfer of the tool from the current borrower (step 750). The user presses or selects the transfer icon and a connection list is displayed to the user, who is able to verify that the correct tool has been selected, to confirm which user/borrower currently has the tool, and to enter a proposed due date by which the proposed borrower agrees to return the transferred tool (step 755).

The system then waits for the user initiating the transfer request to confirm or cancel the request. If the user does not confirm the transaction (step 760), the system determines whether the user has cancelled the transaction (step 765). If the user cancels the transaction, the process ends, and the user returns to the view from which the transfer transaction originated. If the user does not cancel the transaction, the system continues to wait for the user to either confirm or cancel the transaction. If the user confirms the transaction, a transfer request notification is sent to the proposed transferor/transferee-user (step 770). The user who sent the transfer request receives a “pending” tool transfer request notification and is able to continue using the application for other purposes. The user who receives the tool transfer request/offer receives the tool transfer request from the system and either accepts or denies the request (step 775). The recipient-connection either accepts or confirms the request (step 780) or denies or rejects the request (step 785). If the connection denies the request, the system sends a rejection notification back to the initiating user and the process ends. If the connection confirms the request, the tool status for the transferred tool changes to borrowed for the transferee, unavailable to the transferor, both parties receive acceptance notifications, and the current borrower is updated in the tool owner's tool list, and the process ends.

It will be appreciated by one of skill in the art that a bar code scanner, preferably installed on a user's mobile device, can be used as an alternative “front end” process for identifying a tool and then initiating one of the above-described processes, namely, the process for requesting to borrow a tool (FIG. 4), offering to loan out a tool (FIG. 5), checking a tool back in (FIGS. 6A-6B), or initiating a transfer request (FIG. 7). If the tool being scanned has a bar code, when the bar code is scanned, the system first determines whether the bar code has been associated with a specific tool in the system database. If so, then the system determines which user has scanned the bar code. Knowing which user has scanned the bar code determines which options are then presented to the user. For example, (i) if the user scanning the bar code is the tool owner, the scanning of the tool is likely for the purpose of checking the tool back in if the tool had previously been loaned out since it is now back in the possession of the tool owner; (ii) if the user scanning the bar code is the tool owner, the scanning of the tool is likely for the purpose of offering the tool out for loan or updating the tool details in the tool database if the tool was already identified as being in the tool owner's possession; (iii) if the user scanning the bar code is not the tool owner, but is identified as the current borrower of the tool, the scanning of the tool is likely for the purpose of returning the tool to the tool owner, transferring the tool to a different borrower, or requesting a modification to the proposed return date; (iv) if the user scanning the bar code is not the tool owner, and is identified as not being the current borrower of the tool, the scanning of the tool is likely for the purpose of requesting borrowing of the tool from the tool owner or requesting transfer of the tool from the current borrower. Once the bar code has been scanned and the relevant action item has been selected by the user, the system then proceeds with the next steps of the previously described processes. When the bar code is scanned, if it is not already in the system, the system prompts the user as to whether the user wants to add the bar code to an existing database record for one of the user's tools or whether the user wants to create a new tool database record for association with the bar code.

Turning now to FIGS. 8-12, various screen shots from the administrator web interface for an Enterprise user are illustrated.

FIG. 8 illustrates a convention log in screen 800 to the administrative web interface for an Enterprise user.

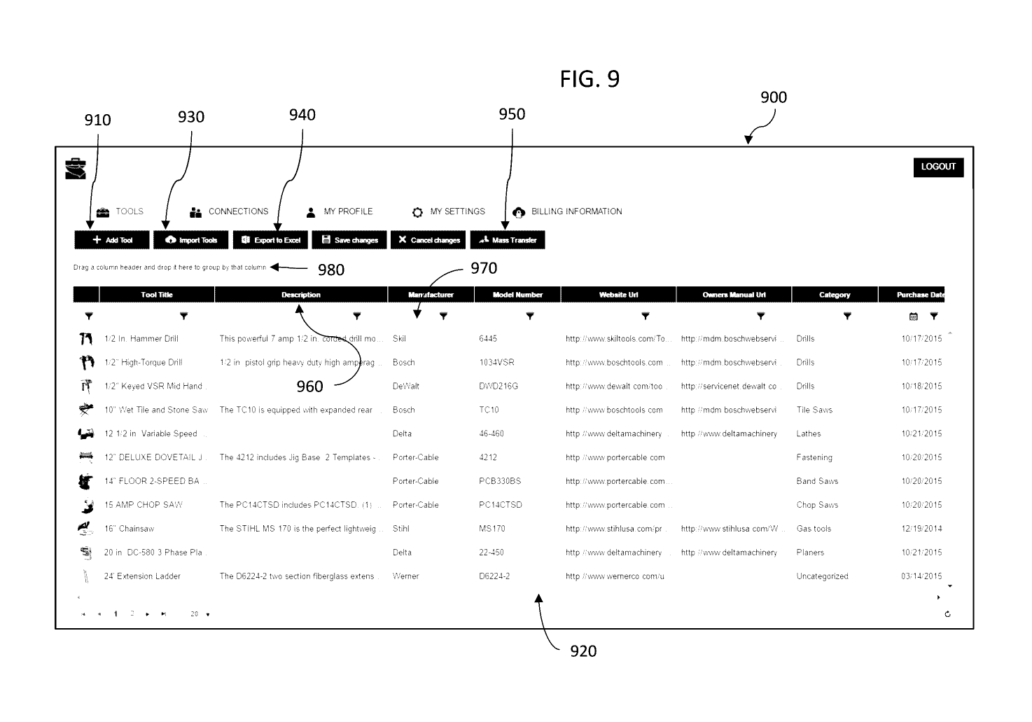

FIG. 9 illustrates a web grid 900 for managing an Enterprise tool owner's item database (under the “Tools” tab at the top of the screen). The Add Tool button 910 creates an empty line on the grid 920 for adding a tool to the database. The Import Tools button 930 opens a dialog box allowing the user to download a CSV template or import a CSV file to populate the tool database. The Export to Excel button 940 exports all tools displayed on the tool grid to an Excel worksheet. The Mass Transfer button 950 allows the user to transfer all tools from one connection to another in one step. Clicking on any column header 960 sorts by that column in ascending or descending order. Clicking in the filter box 970 on a column filters the column contents a number of ways depending on the type of data. Dragging a column header to the grouping bar 980 groups the tool records by that field.

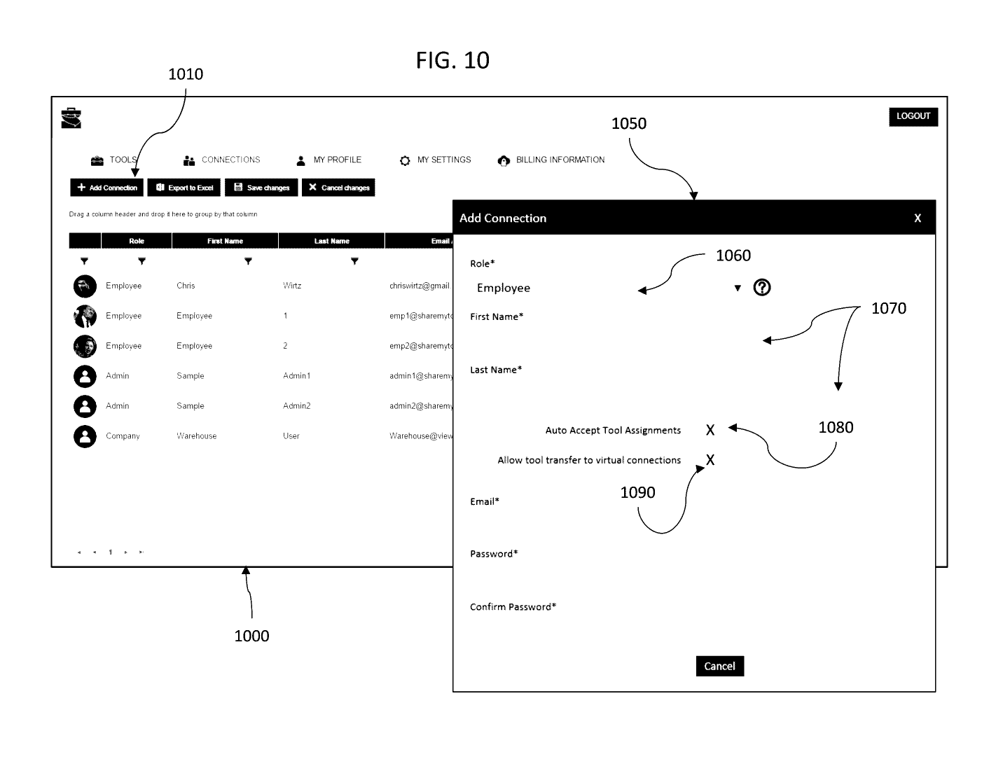

FIG. 10 illustrates a web grid 1000 for managing an Enterprise tool owner's connection list (under the “Connections” tab at the top of the screen). The Add Connection button 1010 displays the Add Connection dialog box 1050. The available roles being Employee, Virtual User, and Administrative User, as shown in field 1060. Employee or administrative connections require first name, last name, email and password. An asterisk designates required fields. Virtual connections require only first and last names.

The different roles and capabilities of an Employee, Administrator, and Virtual User can be summarized as follows. Typically, an Employee: (i) can create personal tools and connections, (ii) can borrow tools from the company/Enterprise and from other employees/connections of the Enterprise; (iii) can transfer tools with other employees; and (iv) receives notifications and acceptance is required for tool transfers or tools loaned for the company if the Auto Accept Tool Assignment box (described below) is not checked. An Administrator: (i) can add edit/delete company tools; (ii) cannot create personal tools; and (iii) can access the web interface, but not the billing tab. A Virtual User/Connection: (i) represents a an employee without a smart phone, a location, a vehicle or a warehouse; and (ii) the Auto Accept Tool Assignment box (described below) must be checked, which requires automatic acceptance of any tool transfers or loans.

If the Auto Accept Tool Assignments box 1090 is checked, the workflow that requires acceptances is bypassed. If the connection role in field 1060 is set to Virtual User, no fields are available except First and Last Name 1070 and Auto Accept Tool Assignments option 1080 defaults to checked. The Virtual User allows a tool owner to assign tools to a nonexistent connection and utilizes the same database and sharing workflow by auto accepting transactions. The Allow Tool Transfer to Virtual Connections option 1090 allows the tool owner to restrict which connections interact with a Virtual User without acceptance.

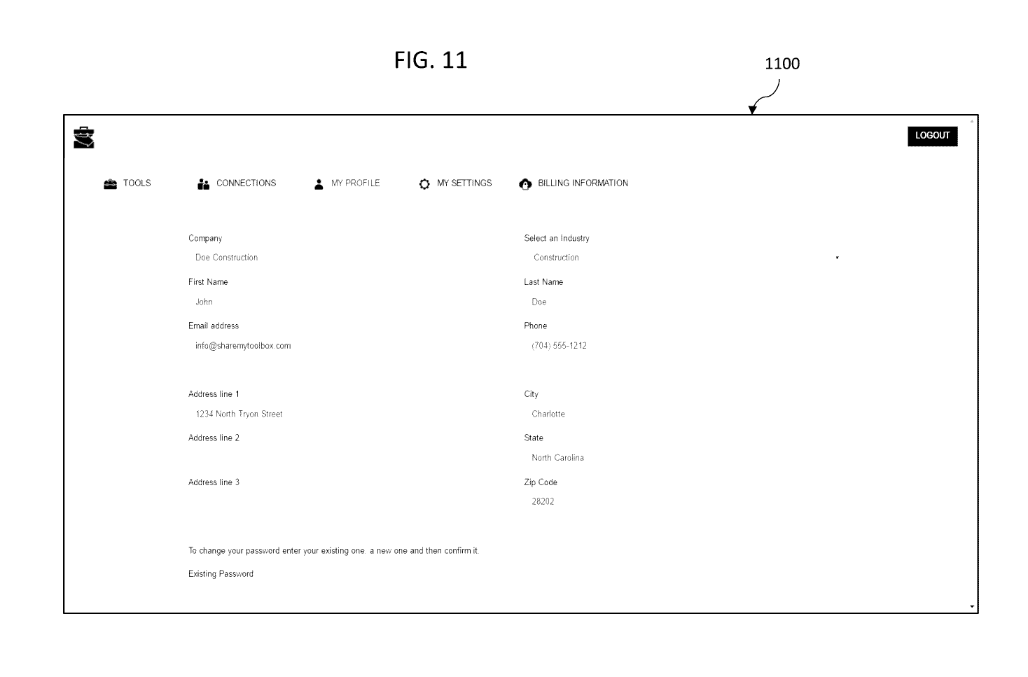

FIG. 11 illustrates the web interface 1100 for managing an Enterprise tool owner's profile (under the “My Profile” tab at the top of the screen). An asterisk designates the required company, industry, first name and last name fields.

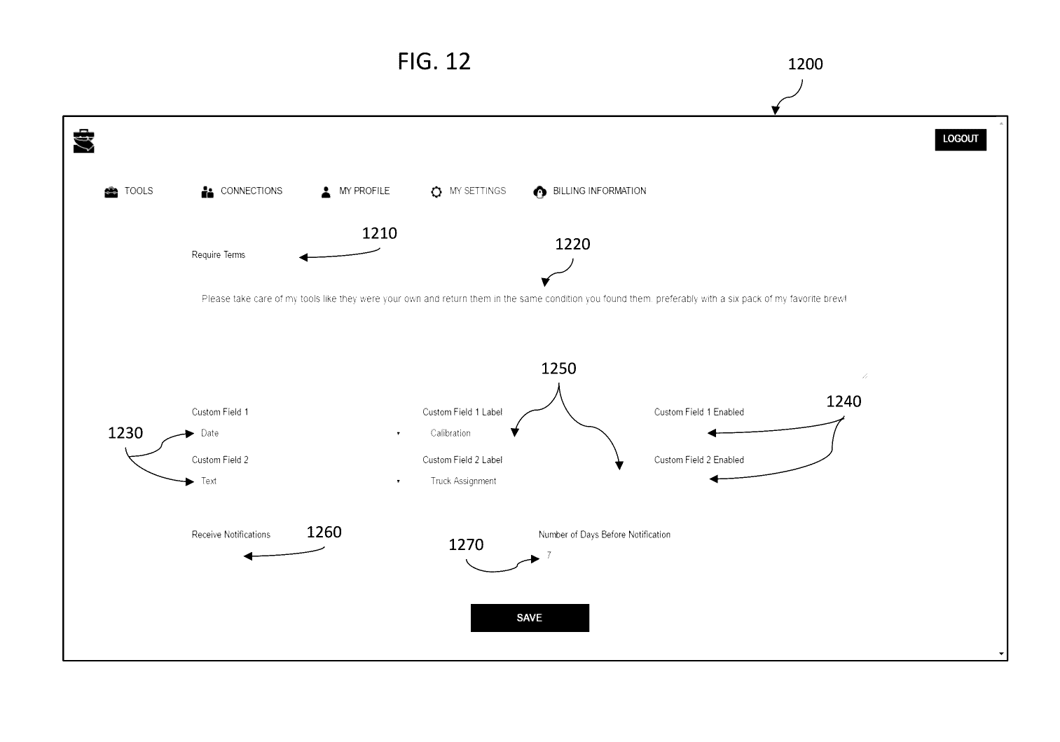

FIG. 12 illustrates the web interface 1200 for managing an Enterprise user's settings (under the “My Settings” tab at the top of the screen). If Require Terms 1210 is set to “yes” or “on,” the tool owner is able to enter terms and conditions text within field 1220 that will be displayed on each tool record associated with the tool owner. The tool owner may enable (or disabled), using toggle selection buttons 1240, two optional Custom Fields 1230. Such custom fields are selectable from a pull down menu and preferably include different category types including but not limited to Date, Text, URL, or Other fields. Each custom field may have a Custom Label typed into fields 1250 by the user to identify that field. The user is also able to toggle off and on using button 1260 whether notifications will be received. The default setting for notifications is “on.” In addition, the user is able to specify in field 1270 the frequency for receiving such notifications.

In view of the foregoing detailed description of preferred embodiments of the present invention, it readily will be understood by those persons skilled in the art that the present invention is susceptible to broad utility and application. While various aspects have been described herein, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

We claim:

1. A system for sharing and tracking tools among a plurality of users in the field without need of a centralized tool repository from which tools are physically loaned out and checked back in upon return, the plurality of users including a tool owner and a plurality of connections of the tool owner, wherein each of the plurality of users has at least one mobile device in electronic communication with a remote management server, the remote management server and each mobile device having a respective at least one processor, memory storage, and a non-transitory computer-readable medium that is usable by the at least one processor and is operatively coupled to the memory storage, storing a user record for each respective user and storing a tool record for one or more tools owned by the tool owner in the memory storage of the remote management server, each user record including a unique user ID and identification of the one or more mobile devices associated with each respective user, each tool record including a unique tool ID associated with each respective tool, each tool record further including the unique user ID of a first user currently in physical possession of the respective tool, the computer-readable medium having stored thereon a sequence of instructions that when executed by the at least one processor causes the remote management server and the mobile devices to perform one or more predetermined actions, comprising:
receiving a call to action from a requesting mobile device to update physical possession of a specific tool from the first user to a second user as reflected in the tool record associated with the specific tool maintained in the memory storage of the remote management server;
determining the user ID of the requesting user based on the mobile device from which the call to action is received;
determining the user ID of the first user based on the tool record associated with the specific tool;
presenting to the requesting user on the requesting mobile device one or more actions that can be selected by the requesting user on the requesting device based on the call to action and based on the user IDs of the requesting user, the first user, and the second user;
receiving the selected action on the requesting device;
after physical receipt of the specific tool by the second user, receiving confirming of receipt of the specific tool on the mobile device of the second user; and
in response to receiving the confirmation of physical receipt of the specific tool, updating current physical possession of the specific tool from the first user to the second user in the tool record of the specific tool.

2. The system of claim 1, wherein the first user and the second user are connections of the tool owner.

3. The system of claim 2, wherein the requesting user is the first user and the selected action comprises sending an offer to the mobile device of the second user for the second user to accept physical transfer of the specific tool, and wherein receiving confirmation of receipt of the specific tool on the mobile device of the second user comprises acceptance of the offer by the second user.

4. The system of claim 3, wherein the offer includes a due date by which the specific tool must be returned by the second user.

5. The system of claim 4, wherein the offer indicates whether the specific tool must be returned directly to the tool owner or back to the first user by the due date and wherein the due date is added to the tool record of the specific tool.

6. The system of claim 2, wherein the requesting user is the second user and the selected action comprises sending a request to the mobile device of the first user for the first user to physically transfer the specific tool to the second user, and further comprising receiving an acceptance of the request by the first user on the mobile device of the first user.

7. The system of claim 6, wherein the request includes a due date by which the second user agrees to return the specific tool.

8. The system of claim 7, wherein the acceptance of the request indicates whether the specific tool must be returned directly to the tool owner or back to the first user by the due date and wherein the due date is added to the tool record of the specific tool.

9. The system of claim 1, wherein the requesting user is both the first user and the tool owner, the second user is a connection of the tool owner, and the selected action comprises sending an offer to the mobile device of the second user for the second user to accept physical loan of the specific tool from the tool owner, and wherein receiving confirmation of receipt of the specific tool on the mobile device of the second user comprises acceptance of the offer by the second user.

10. The system of claim 9, wherein the offer includes a due date by which the specific tool must be returned by the second user to the tool owner and wherein the due date is added to the tool record of the specific tool.

11. The system of claim 1, wherein the requesting user is both the second user and the tool owner, the first user is a connection of the tool owner, and the selected action comprises sending a request to the mobile device of the first user for the first user to physically return the specific tool to the tool owner, and further comprising receiving an acceptance of the request by the first user on the mobile device of the first user.

12. The system of claim 11, wherein the request includes a due date by which the second user agrees to return the specific tool and wherein the due date is added to the tool record of the specific tool.

13. The system of claim 1, wherein the requesting user is the tool owner, both the first user and the second user are connections of the tool owner, and the selected action comprises sending a request to the mobile device of the first user for the first user to physically transfer the specific tool to the second user and sending an offer to the mobile device of the second user for the second user to accept physical transfer of the specific tool from the first user, and further comprising receiving an acceptance of the request by the first user on the mobile device of the first user, and wherein receiving confirmation of receipt of the specific tool on the mobile device of the second user comprises acceptance of the offer by the second user.

14. The system of claim 1, wherein the specific tool is selected from a tool list displayed on the requesting mobile device.

15. The system of claim 14, wherein the tool list identifies a status of each tool listed therein, wherein the status is chosen from one of the following: available for loan, already borrowed, unavailable for loan.

16. The system of claim 15, wherein each respective status is associated with a respective color-coded indicator.

17. The system of claim 16, wherein the specific tool is displayed on the requesting mobile device after a bar code has been scanned from the specific tool or after an RFID has been detected on the specific tool.

18. The system of claim 1, wherein the specific tool is identified using a bar code or RFID reader in electronic communication with the requesting mobile device.

19. The system of claim 1, further comprising receiving a search request for the specific tool based on one or more search parameters specified on the requesting mobile device by the requesting user.

20. The system of claim 1, wherein receiving the selected action is based on input received on the requesting mobile device from the requesting user.
